(19) United States
(12) Patent Application Publication
(10) Pub. No.: US 2020/0044266 A1
(43) Pub. Date: Feb. 6, 2020

(54) FUEL CELL POWER GENERATION PLANT AND METHOD OF COMMUNICATION

(71) Applicant: Cummins Enterprise LLC, Indianapolis, IN (US)

(72) Inventors: Honggang WANG, Clifton Park, NY (US); Ralph TEICHMANN, Niskayuna, NY (US)

(21) Appl. No.: 16/054,474

(22) Filed: Aug. 3, 2018

(51) Int. Cl. H01M 8/04828; H01M 8/04858; H04B 3/54; H04B 3/56

(52) U.S. Cl. CPC H01M 8/0494; H01M 8/0488; H01M 8/04917; H04B 2203/5491; H04B 3/56; H04B 2203/5416; H04B 3/548

(57) ABSTRACT

A fuel cell power generation plant is disclosed. The plant includes fuel cell systems, each of which includes a fuel cell stack, sensors, actuators, a DC-DC converter and a microcontroller. The stack is coupled to a DC bus via the converter. The microcontroller communicates with the sensors, the actuators and the converter, and is configured to acquire sensor data from the sensors and obtain control signals for the actuators and the converter. The plant further includes an inverter coupled with the converter of each system via the DC bus and coupled to a power load, a first power line communication (PLC) modem coupled with the microcontroller of each system, a second PLC modem coupled with the first PLC modem via the DC bus; and a plant controller coupled with the second PLC modem and communicating with the inverter. A method of communication for use in a fuel cell power generation plant is also disclosed.

### BACKGROUND

This disclosure relates generally to the field of fuel cells, and more particularly to a fuel cell power generation plant and a method of communication for use in a fuel cell power generation plant.

Fuel cells are electro-chemical devices which can convert chemical energy from a fuel into electrical energy through an electro-chemical reaction of the fuel, such as hydrogen, with an oxidizer, such as oxygen contained in the atmospheric air. Fuel cell systems are being widely developed as an energy supply system because fuel cells are environmentally superior and highly efficient. As single fuel cell can only generate voltages of about IV, therefore, a plurality of fuel cells are usually stacked together (usually referred to as a fuel cell stack) to get a desired voltage.

A fuel cell power generation plant usually includes a plurality of fuel cell systems for generating power and providing the power to a power load. In the existing fuel cell power generation plant, fuel cell data communication generally uses wired technologies involving extra communication modules and cabling. For example, optical fiber is used as a network transmission medium. However, such the wired communication would need a lot of cables, especially for those remote distributed fuel cell systems, thereby leading to greater installation and maintenance costs.

### BRIEF DESCRIPTION

In one aspect of embodiments of the present disclosure, a fuel cell power generation plant is provided. The fuel cell power generation plant comprises a plurality of fuel cell systems, an inverter, a first power line communication modem, a second power line communication modem and a plant controller. Each of the plurality of fuel cell systems comprises a fuel cell stack for generating power, a plurality of sensors arranged in different locations of the fuel cell system, a plurality of actuators, a DC-DC converter and a microcontroller. The fuel cell stack is coupled to a DC bus via DC-DC converter. The microcontroller communicates with the plurality of sensors, the plurality of actuators and the DC-DC converter, and is configured to acquire sensor data from the plurality of sensors and obtain control signals for the plurality of actuators and the DC-DC converter. The inverter is coupled with the DC-DC converter of each fuel cell system via the DC bus and is coupled to a power load. The first power line communication modem is coupled with the microcontroller of each fuel cell system. The second power line communication modem is coupled with the first power line communication modem via the DC bus. The plant controller is coupled with the second power line communication modem and communicating with the inverter.

In another aspect of embodiments of the present disclosure, a method of communication for use in a fuel cell power generation plant is provided. The fuel cell power generation plant comprises a plurality of fuel cell systems distributed in different regions, and each fuel cell system comprises a fuel cell stack for generating power and a plurality of sensors arranged in different locations of the fuel cell system. The method comprises acquiring, by one of a plurality of microcontrollers, sensor data from sensors of one of the plurality of fuel cell systems, and sending the sensor data of the one fuel cell system to one of a plurality of slave power line communication modems; transmitting, by the one slave power line communication modem, the sensor data of the one fuel cell system via a DC bus to a master power line communication modem; receiving, by the master power line communication modem, the sensor data of the one fuel cell system and sending the sensor data of the one fuel cell system to a plant controller; and controlling, by the plant controller, an inverter coupled via the DC bus to the fuel cell stack of each fuel cell system to regulate a voltage of the DC bus.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic block diagram of an exemplary fuel cell power generation plant in accordance with one embodiment of the present disclosure;

FIG. 2 illustrates a schematic diagram of a fuel cell stack;

FIG. 3 is a schematic block diagram of an exemplary fuel cell power generation plant in accordance with another embodiment of the present disclosure;

FIG. 4 illustrates a schematic block diagram of a DC bus coupler; and

FIGS. 5 and 6 are flow charts of a method of communication for use in a fuel cell power generation plant in accordance with embodiments of the present disclosure.

### DETAILED DESCRIPTION

Embodiments of the present disclosure will be described hereinbelow with reference to the accompanying drawings. In the following description, well-known functions or constructions are not described in detail to avoid obscuring the disclosure in unnecessary detail.

Unless defined otherwise, technical and scientific terms used herein have the same meaning as is commonly understood by one of ordinary skill in the art to which this disclosure belongs. The terms “first”, “second”, and the like, as used herein do not denote any order, quantity, or importance, but rather are used to distinguish one element from another. Also, the terms “a” and “an” do not denote a limitation of quantity, but rather denote the presence of at least one of the referenced items. The term “or” is meant to be inclusive and mean either or all of the listed items. The use of “including”, “comprising” or “having” and variations thereof herein are meant to encompass the items listed thereafter and equivalents thereof as well as additional items. The terms “connected” and “coupled” are not restricted to physical or mechanical connections or couplings, and can include electrical connections or couplings, whether direct or indirect. In addition, Terms indicating specific locations, such as “top”, “bottom”, “left”, and “right”, are descriptions with reference to specific accompanying drawings. Embodiments disclosed in the present disclosure may be placed in a manner different from that shown in the figures. Therefore, the location terms used herein should not be limited to locations described in specific embodiments.

### Embodiment 1—Fuel Cell Power Generation Plant

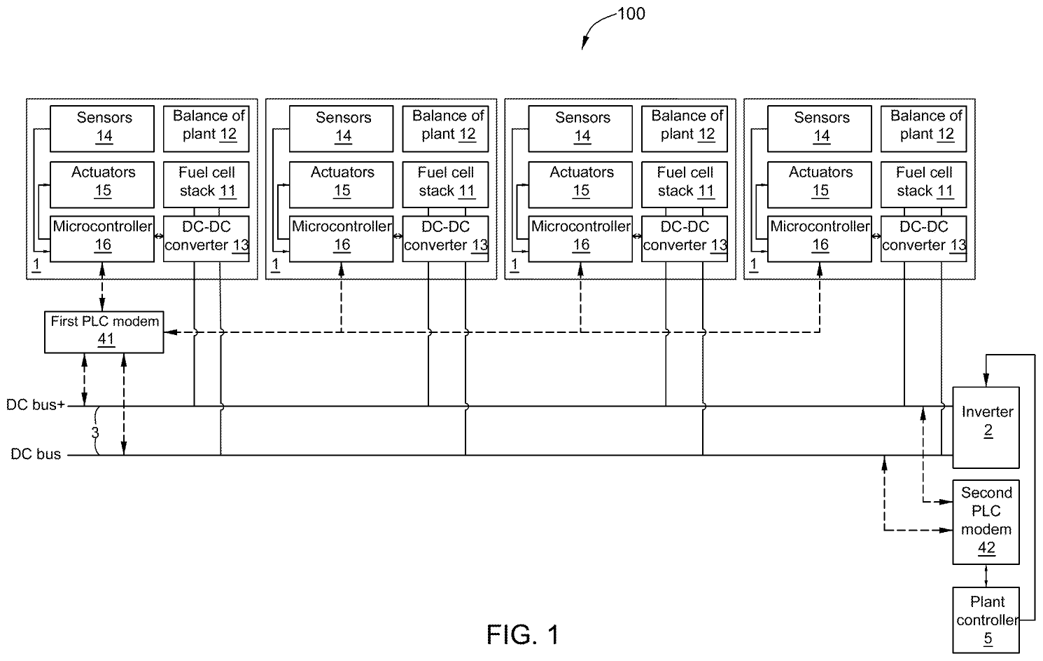

FIG. 1 illustrates a schematic block diagram of an exemplary fuel cell power generation plant 100 in accordance with one embodiment of the present disclosure. As shown in FIG. 1, the exemplary fuel cell power generation plant 100 includes a plurality of fuel cell systems 1. In the figures of the present disclosure, four sets of fuel cell systems 1 are shown as an example. Each of the plurality of fuel cell systems 1 includes a fuel cell stack 11 for generating power and a balance of plant (BOP) 12. The fuel cell stack 11 may include a plurality of fuel cells which are stacked together. The fuel cells may for example include, but are not limited to solid oxide fuel cells (SOFCs). The balance of plant 12 includes all the subsystem of the fuel cell system 1 except for the fuel cell stack 11. For example, the balance of plant 12 may include a fuel supply subsystem, an air supply subsystem, a steam supply subsystem, and a reformer, an anode blower and heat exchangers in an anode recirculation loop. The fuel supply subsystem may include pressure regulating valves, flowrate regulating valves, a desulfurizing device, etc. The air supply subsystem may include a compressor, valves, heat exchangers, etc. The steam supply subsystem may include a water supply source, a steam generating device, steam flowrate and pressure regulating valves etc.

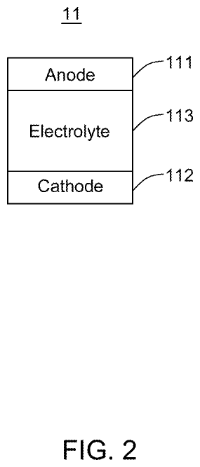

As shown in FIG. 2, The fuel cell stack 11 includes an anode 111, a cathode 112, and an electrolyte 113. The fuel supply subsystem may provide a fuel gas to the anode 111 of the fuel cell stack 11 and the air supply subsystem may provide air to the cathode 112 of the fuel cell stack 11.

The anode 111 may support electrochemical reactions that generate electricity. The fuel gas may be oxidized in the anode 111 with oxygen ions received from the cathode 112 via diffusion through the electrolyte 113. The reactions may create heat, steam and electricity in the form of free electrons in the anode 111, which may be used to supply power to a power load (not shown). The oxygen ions may be created via an oxygen reduction of a cathode oxidant using the electrons returning from the power load into the cathode 112.

The cathode 112 may be coupled to a source of the cathode oxidant, such as oxygen in the atmospheric air. The cathode oxidant is defined as the oxidant that is supplied to the cathode 112 employed by the fuel cell system 1 in generating electrical power. The cathode 112 may be permeable to the oxygen ions received from the cathode oxidant.

The electrolyte 113 may be in communication with the anode 111 and the cathode 112. The electrolyte 113 may pass the oxygen ions from the cathode 112 to the anode 111, and may have little or no electrical conductivity, so as to prevent passage of the free electrons from the cathode 112 to the anode 111.

With continued reference to FIG. 1, the fuel cell power generation plant 100 includes an inverter 2 and a plant controller 5 in communication with the inverter 2. Each fuel cell system 1 includes a DC-DC converter 13 for converting a first direct current (DC) to a second DC. The DC-DC converter 13 is usually a boost converter. The fuel cell stack 11 is coupled to a DC bus 3 via the DC-DC converter 13. The inverter 2 is coupled with the DC-DC converter 13 via the DC bus 3 and the inverter 2 is coupled to a power load, for example a power grid or directly supplied to users including an electric motor, lighting and the like. The inverter 2 may convert a direct current (DC) at a side of the fuel cell stack 11 to an alternating current (AC) at a user side (or a grid side), and the inverter 2 may receive a controlling command from the plant controller 5 and in response to the controlling command, regulate a voltage of the DC bus 3 so as to influence on total power generating capacity control of the fuel cell systems 1.

Each fuel cell system 1 may further include a plurality of sensors 14, a plurality of actuators 15 and a microcontroller 16. The plurality of sensors 14 are arranged in different locations of the fuel cell system 1. The plurality of sensors 14 may include one or more sensors of pressure, thermocouple, flowrate, temperature, current, voltage, gas composition, flow switch, pressure switch and load cells. The plurality of actuators 15 may include one or more actuators of fuel gas flow controller, air gas flow controller, variable frequency drives (VFDs) for air and fuel blower, solenoid valves, and flow control valves. In each fuel cell system 1, the microcontroller 16 may be in communication with the plurality of sensors 14, the plurality of actuators 15 and the DC-DC converter 13, and the microcontroller 16 may acquire sensor data from the plurality of sensors 14, and obtain control signals for the plurality of actuators 15 and the DC-DC converter 13.

The fuel cell power generation plant 100 may further include a first power line communication (PLC) modem 41 and a second power line communication (PLC) modem 42. The first PLC modem 41 is coupled with the microcontroller 16 of each fuel cell system 1. The second PLC modem 42 is coupled with the first PLC modem 41 via the DC bus 3. The plant controller 5 is coupled with the second PLC modem 42.

As shown in FIG. 1, the plurality of fuel cell systems 1 may be arranged in different enclosures. The plant controller 5 is located close to the inverter 2.

### Embodiment 2—Fuel Cell Power Generation Plant

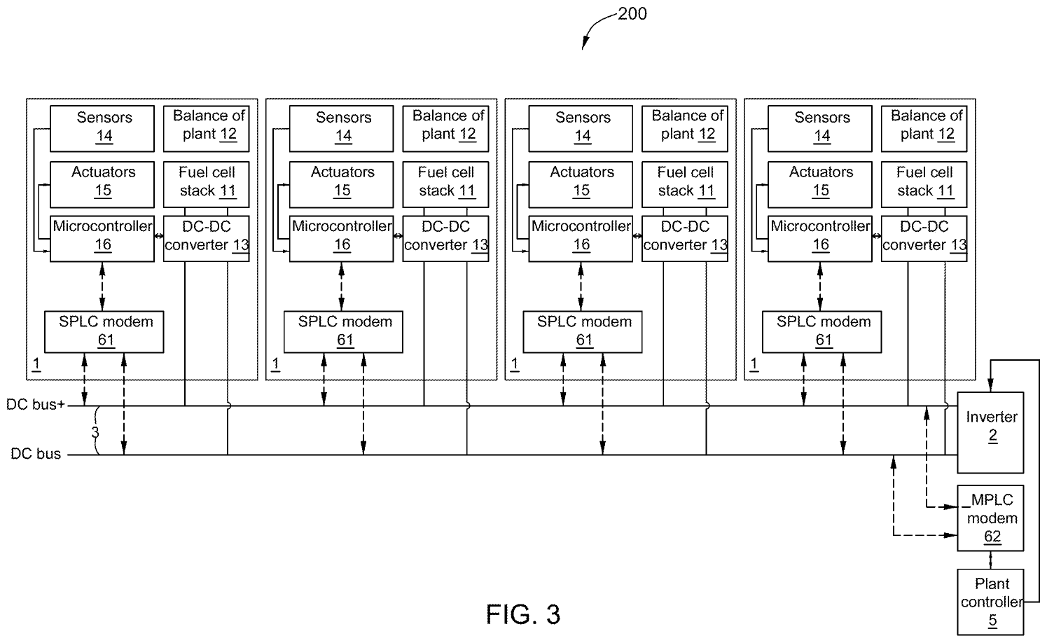

In some embodiments, the plurality of fuel cell systems 1 may be distributed in different regions. FIG. 3 illustrates a schematic block diagram of an exemplary fuel cell power generation plant 200 in accordance with another embodiment of the present disclosure. As shown in FIG. 3, different from the fuel cell power generation plant 100 of FIG. 1, in the fuel cell power generation plant 200 of FIG. 3, the second PLC modem is a master power line communication (MPLC) modem 62, and the first PLC modem comprises a plurality of slave power line communication (SPLC) modems 61. One of the plurality of SPLC modems 61 is coupled with the microcontroller 16 of one of the plurality of fuel cell system 1 and is coupled to the MPLC modem 62 via the DC bus 3.

Each SPLC modem 61 is located close to one corresponding fuel cell system 1. In one embodiment, each of the plurality of SPLC modems 61 is arranged in the enclosure of a corresponding fuel cell system 1.

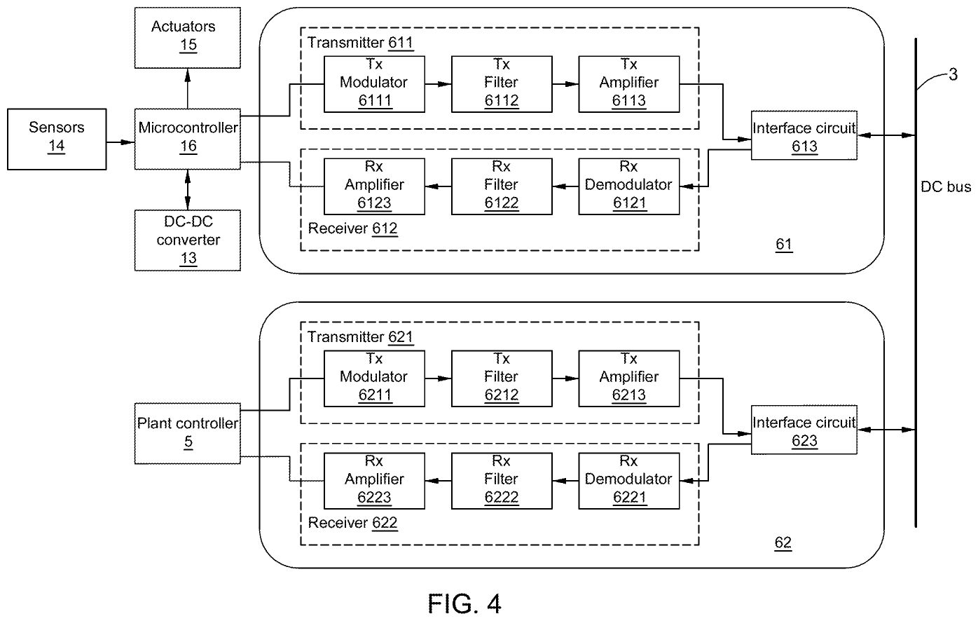

As shown in FIG. 4, the MPLC modem 62 and each of the plurality of SPLC modem 61 may include a DC bus coupler respectively. Each DC bus coupler includes an interface circuit, a transmitter and a receiver. For example, each DC bus coupler 61 includes the transmitter 611, the receiver 612 and the interface circuit 613. The transmitter 611 and the receiver 612 are respectively coupled to the DC bus 3 via the interface circuit 613, and the transmitter 611 and the receiver 612 of each DC bus coupler 61 are coupled with one corresponding microcontroller 16. The transmitter (Tx) 611 of each DC bus coupler 61 is responsible to encode and modulate the commands from the corresponding microcontroller 16 before they are sent down to the DC bus 3, and may include a Tx modulator 6111, a Tx filter 6112 and a Tx amplifier 6113. The receiver (Rx) 612 needs to perform inverse operations than those done by the transmitter 611 and is responsible to demodulate and decode the information received from the DC bus 3. The receiver 612 may include a Rx demodulator 6121, a Rx filter 6122 and a Rx amplifier 6123.

Each DC bus coupler 62 includes the transmitter 621, the receiver 622 and the interface circuit 623. The transmitter 621 and the receiver 622 are respectively coupled with the DC bus 3 via the interface circuit 623, and the transmitter 621 and the receiver 622 of each DC bus coupler 62 are coupled to the plant controller 5. The transmitter (Tx) 621 of the DC bus coupler 62 is responsible to encode and modulate the commands from the plant controller 5 before they are sent down to the DC bus 3, and may include a Tx modulator 6211, a Tx filter 6212 and a Tx amplifier 6213. The receiver (Rx) 622 needs to perform inverse operations than those done by the transmitter 621 and is responsible to demodulate and decode the information received from the DC bus 3. The receiver 622 may include a Rx demodulator 6221, a Rx filter 6222 and a Rx amplifier 6223. The Rx demodulator 6221 may demodulate and decode the information received via the interface circuit 623 from the DC bus 3, and the demodulated information is finally filtered and amplified by the Rx filter 6222 and the Rx amplifier 6223 before received by the plant controller 5.

In operation, when it is required to communicate sensor data of sensors 14 from each microcontroller 16 to the plant controller 5 via the DC bus 3, the Tx modulator 6111 of each DC bus coupler 61 may encode and modulate the sensor data from the corresponding microcontroller 16 and the modulated sensor data are finally filtered and amplified by the Tx filter 6112 and the Tx amplifier 6113 before injection on the DC bus 3 via interface circuit 613. The Rx demodulator 6221 of each DC bus coupler 62 may demodulate and decode the sensor data received via the interface circuit 623 from the DC bus 3, and the demodulated sensor data is finally filtered and amplified by the Rx filter 6222 and the Rx amplifier 6223 before received by the plant controller 5.

When it is required to communicate control signals for actuators 15 and DC-DC converters 13 from the plant controller 5 to the individual microcontrollers 16 via the DC bus 3, the Tx modulator 6211 of each DC bus coupler 62 may encode and modulate the control signals from the plant controller 5 and the modulated control signals are finally filtered and amplified by the Tx filter 6212 and the Tx amplifier 6213 before injection on the DC bus 3 via interface circuit 623. The Rx demodulator 6121 of each DC bus coupler 61 may demodulate and decode the control signals received via the interface circuit 613 from the DC bus 3, and the demodulated control signals is finally filtered and amplified by the Rx filter 6122 and the Rx amplifier 6123 before received by the corresponding microcontroller 16.

Instead of using separate communication cables and control modules, the fuel cell power generation plants 100, 200 of the present disclosure can employ the existing DC bus 3 (power line) as the medium for communicating data and commands reliably between the multiple individual fuel cell systems 1 and the plant controller 5.

In the fuel cell power generation plant 100, 200 of the present disclosure, both communication and power transfer are on the same circuit. Due to no use of communication wires, the fuel cell power generation plant 100, 200 of the present disclosure may have lower cost for commissioning and installation and lower failure rate, and have increased reliability. The fuel cell power generation plant 100, 200 of the present disclosure can reduce the cost by 99%.

For example, for four sets of fuel cell systems, as shown in Tables 1 and 2 below, wherein Table 1 illustrates a cost list of an existing fuel cell power generation plant in which wired fuel cell data communication is used, and Table 2 illustrates a cost list of the fuel cell power generation plant of the present disclosure in which the power line communication is used. In the existing fuel cell power generation plant, one of the plurality of profinet scanners receive the sensor data from a plurality of sensors of one of a plurality of fuel cell systems via corresponding remote IOs. Each profinet scanner is coupled to a profinet controller via a large quantity of cables such as optical fiber, and the profinet controller is coupled with a plant controller.

TABLE 1
existing

| Device | Model number | Unit price ($) | Quantity | Total price ($) |
|---|---|---|---|---|
| Profinet Controller | GEIC695PNC001 | 1300 | 1 | 1300 |
| Profinet Scanner | GEIC695PNS001 | 1200 | 4 | 4800 |
| Cable | Optical fiber | 60 (50m) | 4 | 240 |
| Trench work | Labor | | 1 day | 660 |
| | | | | 7000 |

TABLE 2
the present disclosure

| Device | Model number | Unit price ($) | Node | Total price ($) |
|---|---|---|---|---|
| MPLC | SIG60/YAMAR | 5 | 1 | 5 |
| SPLC | SIG60/YAMAR | 5 | 4 | 20 |
| Cable | NA | NA | NA | |
| | | | | 25 |

It can be clearly seen From Tables 1 and 2, for the fuel cell power generation plant of 1MW, the cost will be dropped by 99.6% from 7000$ to 25$; and for the fuel cell power generation plant of 100MW, the cost will be dropped from 700K$ to 0.25K$. Thus, the fuel cell power generation plant of the present disclosure using the power line communication may cost down greatly.

Method of Communication

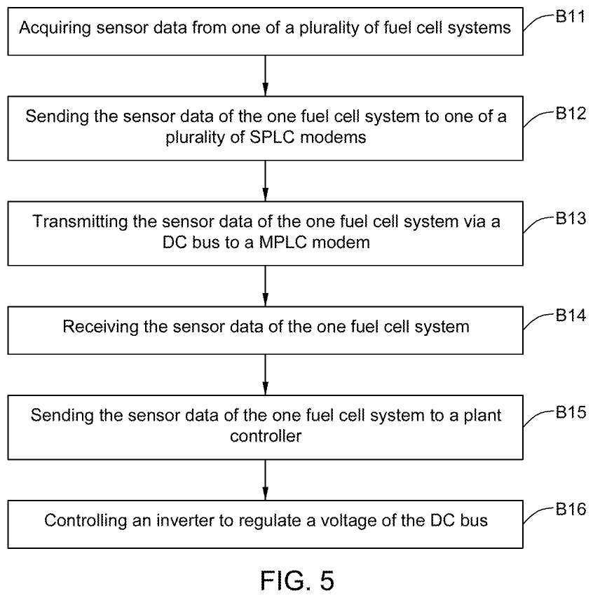

FIG. 5 illustrates a flow chart of an exemplary method of communication in accordance with an embodiment of the present disclosure. The method of communication is for use in a fuel cell power generation plant. The fuel cell power generation plant includes a plurality of fuel cell systems 1 distributed in different regions. Each fuel cell system 1 includes a fuel cell stack 11 for generating power and a plurality of sensors 14 arranged in different locations of the fuel cell system 1. The method may include the following steps.

As shown in FIG. 5, in block B11, sensor data from the sensors 14 of one of the plurality of fuel cell systems 1 may be acquired by one of a plurality of microcontrollers 16.

In block B12, the sensor data of the one fuel cell system 1 may be sent by the one microcontroller 16 to one of a plurality of slave power line communication (SPLC) modems 61.

In block B14, the sensor data of the one fuel cell system 1 may be transmitted by the one SPLC modem 61 via a DC bus 3 to a master power line communication (MPLC) modem 62.

In block B16, the sensor data of the one fuel cell system 1 may be received by the MPLC modem 62.

In block B15, the sensor data of the one fuel cell system 1 may be sent by the MPLC modem 62 to a plant controller 5.

In block B16, an inverter 2 which is coupled via the DC bus 3 to the fuel cell stack 11 of each fuel cell system 1, may be controlled by the plant controller 5 to regulate a voltage of the DC bus 3.

In some embodiments, the method of the present disclosure may further include the following steps.

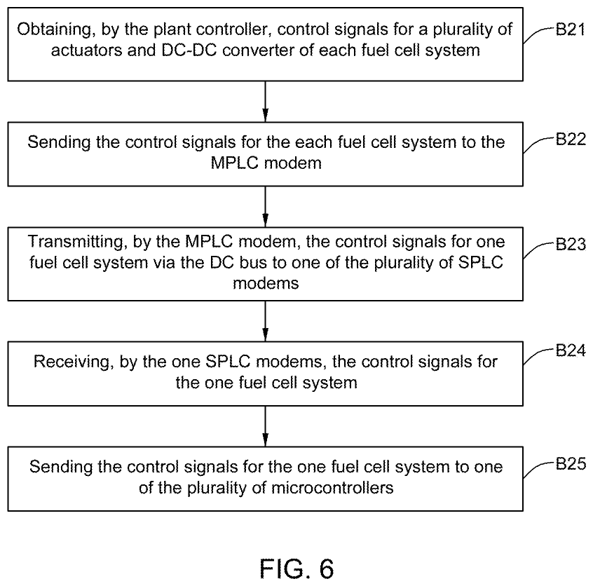

As shown in FIG. 6, in block B21, control signals for the plurality of actuators 15 and the DC-DC converter 13 of each fuel cell system 1 may be obtained by the plant controller 5.

In block B22, the control signals for the each fuel cell system 1 may be sent by the plant controller 5 to the MPLC modem 62.

In block B23, the control signals for one fuel cell system 1 may be transmitted by the MPLC modem 62 via the DC bus 3 to one of the plurality of SPLC modems 61.

In block B24, the control signals for the one fuel cell system 1 may be received by the one SPLC modem 61.

In block B25, the control signals for the one fuel cell system 1 may be sent by the one SPLC modem 61 to one of the plurality of microcontrollers 16.

Therefore, data and signal communication between the microcontrollers 16 of the respective fuel cell systems 1 and the plant controller 5 on the DC bus 3 may be completed by means of the respective SPLC modems 61 and the MPLC modem 62.

The method of the present disclosure may employ the existing DC bus 3 (power line) as the medium to communicate data and commands reliably between the multiple individual fuel cell systems 1 and the plant controller 5 of the fuel cell power generation plant. Thus, the method of the present disclosure may make the fuel cell power generation plant have lower cost for commissioning and installation and can reduce the cost by 99%. Furthermore, the method of the present disclosure may make the fuel cell power generation plant have lower failure rate, and increase reliability of the fuel cell power generation plant.

While steps of the method of communication in accordance with embodiments of the present disclosure are illustrated as functional blocks, the order of the blocks and the separation of the steps among the various blocks shown in FIG. 5 are not intended to be limiting. For example, the blocks may be performed in a different order and a step associated with one block may be combined with one or more other blocks or may be sub-divided into a number of blocks.

While the disclosure has been illustrated and described in typical embodiments, it is not intended to be limited to the details shown, since various modifications and substitutions can be made without departing in any way from the spirit of the present disclosure. As such, further modifications and equivalents of the disclosure herein disclosed may occur to persons skilled in the art using no more than routine experimentation, and all such modifications and equivalents are believed to be within the spirit and scope of the disclosure as defined by the following claims.

What is claimed is:

1. A fuel cell power generation plant, comprising:
a plurality of fuel cell systems, each of which comprises:
a fuel cell stack for generating power;
a plurality of sensors arranged in different locations of the fuel cell system;
a plurality of actuators;
a DC-DC converter via which the fuel cell stack is coupled to a DC bus; and
a microcontroller communicating with the plurality of sensors, the plurality of actuators and the DC-DC converter, and configured to acquire sensor data from the plurality of sensors and obtain control signals for the plurality of actuators and the DC-DC converter;
an inverter coupled with the DC-DC converter of each fuel cell system via the DC bus and coupled to a power load;
a first power line communication modem coupled with the microcontroller of each fuel cell system;
a second power line communication modem coupled with the first power line communication modem via the DC bus; and
a plant controller coupled with the second power line communication modem and communicating with the inverter.

2. The fuel cell power generation plant of claim 1, wherein the plurality of fuel cell systems are in different enclosures.

3. The fuel cell power generation plant of claim 2, wherein the plurality of fuel cell systems are distributed in different regions.

4. The fuel cell power generation plant of claim 3, wherein the second power line communication modem is a master power line communication modem, and the first power line communication modem comprises a plurality of slave power line communication modems, one of which is coupled with the microcontroller of one of the plurality of fuel cell systems and is coupled to the master power line communication modem via the DC bus.

5. The fuel cell power generation plant of claim 4, wherein each of the plurality of slave power line communication modems is arranged in the enclosure of one corresponding fuel cell system.

6. The fuel cell power generation plant of claim 4, wherein each of the master power line communication modem and the plurality of slave power line communication modem comprises a DC bus coupler.

7. The fuel cell power generation plant of claim 6, wherein the DC bus coupler comprises an interface circuit, a transmitter and a receiver, the transmitter and the receiver being respectively coupled to the DC bus via the interface circuit.

8. The fuel cell power generation plant of claim 1, wherein the plant controller is located close to the inverter.

9. The fuel cell power generation plant of claim 1, wherein the plurality of sensors comprise one or more sensors of pressure, thermocouple, flowrate, temperature, current, voltage, gas composition, flow switch, pressure switch and load cells.

10. The fuel cell power generation plant of claim 1, wherein the plurality of actuators comprise one or more actuators of fuel gas flow controller, air gas flow controller, variable frequency drives for air and fuel blower, solenoid valves, and flow control valves.

11. A method of communication for use in a fuel cell power generation plant, wherein the fuel cell power generation plant comprises a plurality of fuel cell systems distributed in different regions, and each fuel cell system comprises a fuel cell stack for generating power and a plurality of sensors arranged in different locations of the fuel cell system, the method comprising:
acquiring, by one of a plurality of microcontrollers, sensor data from sensors of one of the plurality of fuel cell systems, and sending the sensor data of the one fuel cell system to one of a plurality of slave power line communication modems;
transmitting, by the one slave power line communication modem, the sensor data of the one fuel cell system via a DC bus to a master power line communication modem;
receiving, by the master power line communication modem, the sensor data of the one fuel cell system and sending the sensor data of the one fuel cell system to a plant controller; and
controlling, by the plant controller, an inverter coupled via the DC bus to the fuel cell stack of each fuel cell system to regulate a voltage of the DC bus.

12. The method of claim 11, wherein each fuel cell system comprises a plurality of actuators and a DC-DC converter via which the fuel cell stack is coupled to the DC bus, and the method comprises:
obtaining, by the plant controller, control signals for the plurality of actuators and the DC-DC converter of each fuel cell system and sending the control signals for the each fuel cell system to the master power line communication modem;
transmitting, by the master power line communication modem, the control signals for one fuel cell system via the DC bus to one of the plurality of slave power line communication modems; and
receiving, by the one slave power line communication modem, the control signals for the one fuel cell system and sending the control signals for the one fuel cell system to one of the plurality of microcontrollers.
